(19) United States
(12) Patent Application Publication
(10) Pub. No.: US 2024/0127150 A1
(43) Pub. Date: Apr. 18, 2024

(54) METADATA-DRIVEN DYNAMIC USER INTERFACE FOR REGISTRATION AND EXECUTION OF VENDOR-AGNOSTIC SERVICES

(71) Applicant: Oracle International Corporation, Redwood Shores, CA (US)

(72) Inventors: Dawn Abraham, Foster City, CA (US); Yao Yao, Issaquah, WA (US); Harshavardhan Takle, Foster City, CA (US); Kavin Kumar Kuppusamy, Fremont, CA (US)

(73) Assignee: Oracle International Corporation, Redwood Shores, CA (US)

(21) Appl. No.: 18/323,242

(22) Filed: May 24, 2023

Related U.S. Application Data
(60) Provisional application No. 63/416,584, filed on Oct. 16, 2022.

(51) Int. Cl. G06Q 10/0633; G06F 8/38; G06Q 30/0201

(52) U.S. Cl. CPC G06Q 10/0633; G06F 8/38; G06Q 30/0201

(57) ABSTRACT

In one or more embodiments, a metadata-driven user interface is implemented for presenting a set of available services, provided by a plurality of vendors, to a particular service consumer. The system queries metadata associated with of a set of candidate vendors to identify services provided by the candidate vendors that are available to a service consumer. The system generates and customizes the meta-driven interface for the service consumer based on the services available. The system receives user input selecting at least one of the services provided by a vendor. The system then queries configuration information associated with the particular service. The configuration information includes, for example, a workflow associated with the service, and identification of the service consumer's information to be used in execution of the workflow associated with the service. The system obtains the service consumer's information and uses the service consumer's information to cause execution of the workflow.

### INCORPORATION BY REFERENCE; DISCLAIMER

The following application is hereby incorporated by reference: application No. 63/416,584 filed on Oct. 16, 2022. The applicant hereby rescinds any disclaimer of claims scope in the parent application(s) or the prosecution history thereof and advise the USPTO that the claims in the application may be broader than any claim in the parent application(s).

### TECHNICAL FIELD

The present disclosure relates to an interface for integrating data from various entities into a universal architecture, and more specifically to automatically selecting process flows for specific entities based on detected characteristics of the entities and metadata provided by the entities.

### BACKGROUND

When building an interface, many different factors are taken into consideration by a designer, such as what type of content appears on the various different pages of the interface, how the interface can be navigated, who will have access to the interface, etc. All of these various factors are taken into consideration when ultimately designing the interface so that a user can intuitively navigate through the information contained in, and accessible by, the interface.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1A shows an example vendor-agnostic service architecture, in accordance with one or more embodiments;

FIG. 1B shows an example data repository that may be used with the vendor-agnostic service architecture, in accordance with one or more embodiments;

FIG. 2 shows an example system for activating a service for use by a consumer, in accordance with one or more embodiments;

FIG. 3 shows an example system to provide a connected platform in accordance with one or more embodiments;

FIG. 4 illustrates an example method for providing services to a service consumer in accordance with one or more embodiments; and

FIG. 5 shows a block diagram that illustrates a computer system in accordance with one or more embodiments.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention.
1. GENERAL OVERVIEW
2. VENDOR-AGNOSTIC SERVICE ARCHITECTURE
3. SYSTEM FOR ACTIVATING A SERVICE FOR USE BY A CONSUMER
4. CONNECTED PLATFORM
5. EXAMPLE EMBODIMENTS
6. COMPUTER NETWORKS AND CLOUD NETWORKS
7. MISCELLANEOUS; EXTENSIONS
8. HARDWARE OVERVIEW

### 1. GENERAL OVERVIEW

One or more embodiments construct a customized metadata-driven user interface for connecting a set of vendor services to a service consumer. The system queries metadata associated with of a set of candidate vendors to identify services provided by the set of candidate vendors that are available to a service consumer. The system generates and customizes the meta-driven interface for the service consumer based on the services available to the service consumer. The system receives user input selecting at least one of the services provided by a vendor. The system then queries configuration information associated with the particular service. The configuration information includes, for example, a workflow associated with the particular service, and the service consumer's information to be used in execution of the workflow associated with the particular service. The system uses the service consumer's information to cause execution of the workflow for setup and/or use of the particular service.

One or more embodiments described in this Specification and/or recited in the claims may not be included in this General Overview section.

### 2. VENDOR-AGNOSTIC SERVICE ARCHITECTURE

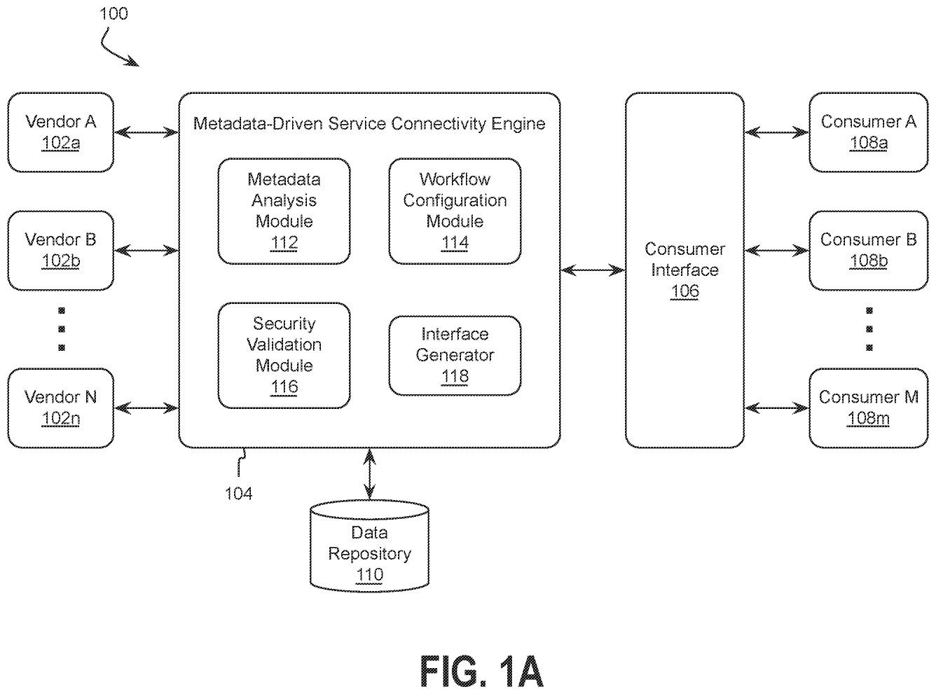

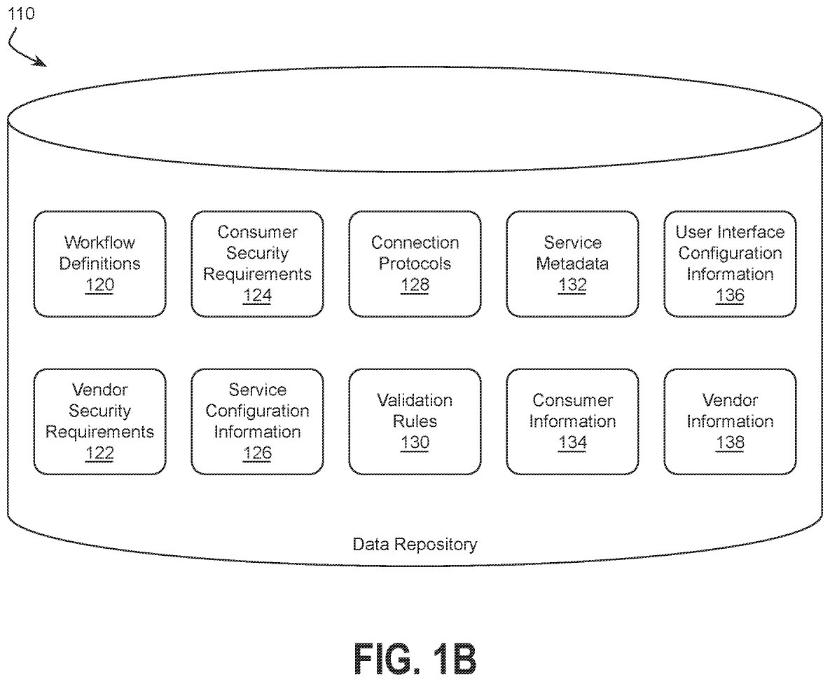

FIG. 1A shows a vendor-agnostic service architecture 100, in accordance with one or more embodiments. The vendor-agnostic service architecture 100 includes a metadata-driven service connectivity engine 104 for generating and providing one or more services by one or more of the various vendors 102 (e.g., vendor A 102a, vendor B 102b, . . . , vendor N 102n) for one or more of the various consumers 108 (e.g., consumer A 108a, consumer B 108b, consumer M 108m). There may be any number of vendors 102 and consumers 108, and these numbers may be equal or inequal, e.g., more vendors 102 than consumers 108, more consumers 108 than vendors 102. The metadata-driven service connectivity engine 104 includes various modules configured to perform different functions for registration, security, enforcement, validation, service provision, etc.

Some example modules are shown and described herein, but more or less modules may be included in the metadata-driven service connectivity engine 104, according to embodiments described herein. In one embodiment, the metadata-driven service connectivity engine 104 may identify a plurality of candidate vendors 102 for providing services to one or more of the service consumers 108. The candidate vendors 102 may include any vendor that can provide one or more services to at least one of the service consumers 108, either on a business-to-business (B2B) basis or front-facing consumer serving organizations.

Some example vendors 102 include, but are not limited to, ride-sharing companies, financial planning companies, banks, investment brokerages, credit card management companies, cloud computing companies, artificial intelligence (AI) companies, etc. Virtually any modern business may provide some type of services to its own customers, and the vendor-agnostic service architecture 100 is able to identify which, out of all of the various vendors 102 that have registered or provided data for inclusion in the search, would be able to provide services to any particular service consumer 108. Moreover, any type of services may be provided, as long as the vendor-agnostic service architecture 100 is able to ascertain what services are able to be provided by the individual candidate vendors 102. In addition, some services may not be available for certain types of service consumers 108 (e.g., B2B only, retail only, geographic restrictions, etc.).

The metadata analysis module 112 is configured to analyze metadata to determine which services can be provided for particular consumers 108, based on the needs and requirements of the various consumers 108. The metadata analysis module 112 is also configured to analyze metadata to determine which services particular vendors 102 can provide. In other words, the vendor-agnostic service architecture 100 ascertains specific services that are applicable and usable by respective service consumers 108 out of all services that each of the candidate vendors 102 can provide based on metadata provided by the vendors 102 and consumers 108.

For example, if a vendor 102 submits metadata indicating that the vendor is capable providing security service(s), the metadata analysis module 112 will analyze this metadata to determine which type of security protocols are used in the security service(s), data requirements for input data, additional information needed to perform the security service(s) (e.g., passwords, login credentials, data size limits, encryption information, decryption information, etc.), output data format, protocols relevant to the security service(s) for exchanging data between the vendor 102 and consumer(s) 108, etc. This information may then be stored in the data repository 110, in an approach.

In another example, if a certain consumer (e.g., consumer B 108b) requests generative AI services to be provided for inclusion in a productivity software, the metadata analysis module 112 will analyze the metadata provided by the various vendors 102 to determine which vendor can provide the requested generative AI services. This information may then be stored in the data repository 110, in an approach.

In one embodiment, the metadata associated with a particular vendor (e.g., vendor A 102a) may include configuration information corresponding to security for vendor A 102a. This security metadata may describe security techniques that are employed by vendor A 102a, security protocols used by vendor A 102a and designate formats for the security protocols, security requirements of vendor A 102a for its own data and any data that may be provided to vendor A 102a, and/or security credentials to access data, encrypt data, decrypt data, encode data, decode data, etc.

In an approach, the metadata associated with a particular vendor (e.g., vendor B 102b) may include configuration information corresponding to connectivity for data exchange for vendor B 102b. This connectivity metadata may describe techniques for connecting to one or more associated services and/or resources, protocols used by vendor B 102b for connecting to one or more associated services and/or resources, connection credentials for accessing data, one or more associated services, and/or resources, timing for collecting and/or providing data to one or more associated services and/or resources, requirements, techniques, and/or protocols for encrypting/decrypting data to be exchanged, etc.

In an embodiment, the metadata associated with a particular vendor (e.g., vendor N 102n) may include configuration information corresponding to registration for vendor N 102n. This registration metadata may enable and/or provide information useful for vendor registration with the connected platform and/or flow registration for enabling one or more particular flows associated with vendor N 102n. This registration may be used for real-time workflow registration, that may proceed promptly as the registration metadata is received in an approach. In an example, offline workflows may be described in the metadata and registered for future use.

The workflow configuration module 114 is configured to generate a workflow for each respective service that is to be provided by a vendor 102. Each service provided by a candidate vendor 102 may have data associated therewith which dictates what information about the service consumer 108 is needed to properly provide the particular service. This information may be provided as metadata in association with the service to be provided, such as a service package.

The metadata analysis module 112 queries configuration information associated with the each service provided by the various vendors. Based on this query, the workflow configuration module 114 can ascertain configuration information for each particular service that may be provided through the metadata-driven service connectivity engine 104. In an approach, the configuration information may actually define a workflow for initiating the particular service from the associated vendor for a service consumer (which may then select and initiate such service through the consumer interface 106).

In an approach, the configuration information may define a set of consumer information that is (a) associated with the recipient service consumer, and (b) used for executing the workflow for initiating the particular service from the associated vendor for the recipient service consumer.

The metadata analysis module 112 may also obtain the set of consumer information associated with each service consumer 108. In one approach, the metadata analysis module 112 may obtain the set of consumer information by polling a recipient service consumer 108 to make determinations about details that are needed by a particular selected service (e.g., operating system, memory type and size, processor speed and capabilities, network bandwidth, data types, architecture of the service consumer, security credentials, etc.) once the recipient service consumer 108 has selected, via the consumer interface 106, for the associated vendor to provide the particular selected service. The metadata-driven service connectivity engine 104 uses the set of consumer information to cause execution of the workflow for initiating the particular selected service from the associated vendor for the recipient service consumer.

The security validation module 116 is configured to provide security pattern recognition and provision of security protocols for the various vendors 102. Some example security functions that may be provided by the security validation module 116 on data provided by the various consumers 108 include, but are not limited to, open authentication (oAuth), mutual or two-way authentication like mutual transport layer security (mTLS), pretty good privacy (PGP), secure shell protocol (SSH), data authentication/signing, etc.

In an example, the security validation module 116 may perform security functionality specified by a particular consumer 108 on data that is provided by the particular consumer 108 via the consumer interface 106. In a further embodiment, the metadata-driven service connectivity engine 104 may provide data on which one or more security services have been performed back to the particular consumer 108 via the consumer interface 106.

In an example, the security validation module 116 may authenticate data received from consumer B 108b in accordance with authentication protocols provided and/or selected by consumer B 108b via the consumer interface 106, prior to and/or after a selected vendor B 102b has performed one or more services on the data. Which data is authenticated, which protocols are used, and the communication protocols between consumer B 108b and vendor B 102b are specified by one or more workflows generated by the workflow configuration module 114.

The interface generator 118 is configured to generate the consumer interface 106 for receiving requests, inputs, and/or data from the various consumers 108, and providing the received information to the metadata-driven service connectivity engine 104 for analysis thereof.

Some example functions that may be provided by the interface generator 118 include, but are not limited to, providing one or more REST application programming interfaces (APIs) to allow a consumer 108 to invoke one or more services provided by a vendor 102, secure file transfer protocol (SFTP), webhooks, email, short messaging service (SMS), etc.

The interface generator 118 generates the metadata-driven consumer interface 106 to facilitate selection of one or more services by a consumer 108, and for receiving input from one or more of the consumers 108. The metadata-driven consumer interface 106 may include sets of service(s) respectively provided by the various candidate vendors 102. The sets of service(s) may be displayed in any of: drop-down lists, visual listings, a tiled view with accompanying text details, etc. Selection of any particular service may reveal additional details about the service, initiate a connection between the consumer 108 and vendor 102 associated with the selected service, provide details about vendors 102 which provide the selected service, etc.

The metadata-driven consumer interface 106 is presented to the various service consumers 108. Presentation of the metadata-driven consumer interface 106 may include sending the metadata-driven consumer interface 106 to a computing device at one or more of the service consumers 108 for use by the computing device, displaying the metadata-driven consumer interface 106 on a display of a system, providing the metadata-driven consumer interface 106 to a designated device of one or more of the service consumers 108, hosting the metadata-driven consumer interface 106 on a website or network, etc.

Once the metadata-driven consumer interface 106 is presented to the service consumers 108 (or individual thereof), one or more user inputs may be received via the metadata-driven consumer interface 106 to select which of the candidate services are to be provided to the selecting service consumer 108.

In one embodiment, data related to each of the vendors 102, data related to each of the consumers 108, metadata provided by the vendors 102 and consumers 108, workflows, security protocols and requirements, interface data, etc., may be stored to the data repository 110. This data may be generated, collected, authenticated, and/or validated by any of the modules 112, 114, 116, 118, in one or more approaches. The various data available in the data repository 110 is described in more detail in FIG. 1B. Data repository 110 may include any type of storage unit and/or device (e.g., a file system, database, collection of tables, or any other storage mechanism) for storing data. Further, the data repository 110 may include multiple different storage units and/or devices. The multiple different storage units and/or devices may or may not be of the same type or located at the same physical site. Further, the data repository 110 may be implemented or may execute on the same computing system as the vendor-agnostic service architecture 100. Alternatively, or additionally, the data repository 110 may be implemented or executed on a computing system separate from the vendor-agnostic service architecture 100. The data repository 110 may be communicatively coupled to any device for transmission and receipt of data via a direct connection or via a network.

FIG. 1B shows an example data repository 110 that may be used with the vendor-agnostic service architecture 100 of FIG. 1A, in accordance with one or more embodiments. The data repository 110 may include input data, output data, and intermediary data for any of the various modules operating within the metadata-driven service connectivity engine 104, provided to the metadata-driven service connectivity engine 104 by any of the various consumers 108, and/or provided to the metadata-driven service connectivity engine 104 by any of the various vendors 102, in various approaches.

In an example, and in no way limiting on which data may be stored to the data repository 110, FIG. 1B shows the data repository 110 including workflow definitions 120 generated by the workflow configuration module 114, consumer security requirements 124 provided by one or more of the consumers 108, connection protocols 128 that may be used to import and/or export data between the various vendors 102 and consumers 108, service metadata 132, user interface configuration information 136, vendor security requirements 122, service configuration information 126, validation rules 130, consumer information 134, and vendor information 138.

Workflow definitions 120 may be generated by the workflow configuration module 114 for each service provided by a vendor 102. In an approach, a workflow definition may be applicable to only a single service provided by a particular vendor 102 as that service is to be used by a particular consumer 108 (e.g., a one-to-one relationship). In another approach, a workflow definition may be defined for a service provided by a particular vendor 102 that allows for any consumer 108 to make use of the service (e.g., a one-to-many relationship). According to another approach, a workflow definition may be defined for a group of services provided by one or more vendors 102 that allows for a single consumer 108 to make use of the group of services (e.g., a many-to-one relationship). In an approach, a workflow definition may be defined for multiple services provided by one or more vendors 102 that allows for any consumer 108 to make use of the multiple services (e.g., a many-to-many relationship).

Consumer security requirements 124 may be determined from information received from one or more of the various consumers 108. The consumer security requirements 124 may include, but are not limited to, security protocols for the consumer such as use and provisioning information for oAuth, mutual or two-way authentication like mTLS, PGP, SSH, data authentication/signing, etc.

Connection protocols 128 may be stipulated by vendors 102, consumers 108, or both. These connections protocols 128 define how to exchange data between the consumers 108 and vendors 102, transmission protocols, signing/authentication information, and any other protocols used in the exchange of data for provision of the services by the various vendors 102 for the various consumers 108.

Service metadata 132 may include information relevant to the individual services that are provided by the various vendors 102. The service metadata 132 may be obtained by the metadata analysis module 112, in one approach. This information may include any of the following: name of the service, purpose of the service, field of the service (banking, retail, currency exchange, travel, ride-sharing, shopping, AI, data security, cloud computing, etc.), input(s) required for the service, output(s) provided by the service, protocol(s) associated with the service, restriction(s) on what kind of consumer can use the service (B2B, retail consumer, etc.), cost of the service (resources and/or financial), etc.

User interface configuration information may include a layout for the metadata-driven consumer interface 106, number and identification of services that are available, number and identification of vendors that provide the services, protocols for display and/or provision of the consumer interface, etc. The layout may be based on the sets of service(s) provided by the vendors 102. In other words, the number and types of services that are capable of being provided may be used in determining how best to present the sets of service(s) available in the consumer interface, and which candidate vendor will provide each particular service. The layout may have any conventional arrangement, including lists, separation into categories, graphical representations and logos, required information to make use of the service, etc. This information may be stored to the data repository 110 for use by the interface generator 118 in generating the metadata-driven consumer interface 106.

Vendor security requirements 122 may be determined from information received from one or more of the various vendors 102. The vendor security requirements 122 may include, but are not limited to, security protocols for the vendor such as use and provisioning information for oAuth, mutual or two-way authentication like mTLS, PGP, SSH, data authentication/signing, etc.

Service configuration information 126 may include information relevant to the individual services that are provided by the various vendors 102. The service configuration information 126 may be generated by the workflow configuration module 114, in one approach. This information may include any of the following: name of the service, purpose of the service, field of the service (banking, retail, currency exchange, travel, ride-sharing, shopping, AI, data security, cloud computing, etc.), input(s) required for the service, output(s) provided by the service, protocol(s) associated with the service, restriction(s) on what kind of consumer can use the service (B2B, retail consumer, etc.), cost of the service (resources and/or financial), etc. The service configuration information 126 may be used for provision of the various services, through the metadata-driven service connectivity engine 104, for any of the various consumers 108.

Validation rules 130 may include any specific rules that are implemented by a consumer 108, a vendor 102, or the metadata-driven service connectivity engine 104 for securing data exchange between the various parties. These validation rules may dictate provision of security protocols for data exchange, and provide guidance on how and when to implement security functions such as oAuth, mutual or two-way authentication like mTLS, PGP, SSH, data authentication/signing, etc.

Consumer information 134 includes any relevant information about the various consumers 108, such as name, location, contact information, services utilized, historical service usage, vendor(s) previously used, data types used, protocols used, security preferences, size, financial details for assessing costs associated with using the metadata-driven service connectivity engine 104, etc.

Vendor information 138 includes any relevant information about the various vendors 102, such as name, location, contact information, services provided, historical service provision, consumer(s) previously served, data types used, protocols used, security preferences, size, financial details for assessing payments/costs associated with using the metadata-driven service connectivity engine 104, etc.

### 3. SYSTEM FOR ACTIVATING A SERVICE FOR USE BY A CONSUMER

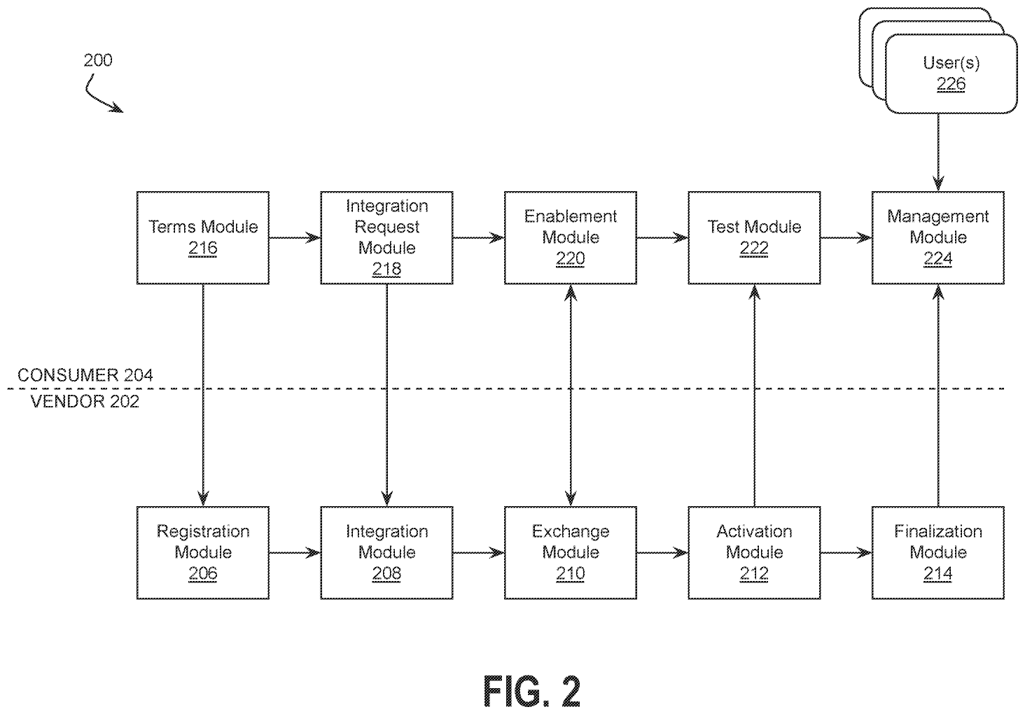

FIG. 2 illustrates an example system 200 for activating a service for use by a consumer, in accordance with one or more embodiments. In one or more embodiments, the system 200 may include more or fewer components than the components illustrated in FIG. 2. The components illustrated in FIG. 2 may be local to or remote from each other. The components illustrated in FIG. 2 may be implemented in software and/or hardware. Each component may be distributed over multiple applications and/or machines. Multiple components may be combined into one application and/or machine. Operations described with respect to one component may instead be performed by another component.

FIG. 2 is split into two portions, a portion associated with a services vendor 202, and a portion associated with a services consumer 204. The services vendor 202 is configured to register consumers and enable applicable services for the registered consumers in registration module 206. Once a consumer is registered, this registration information may be provided to integration module 208 to initiate integration of the services with the consumer's architecture. Integration module 208 receives information from integration request module 218 of the consumer 204, which requests integration of the services provided by vendor 202 into the architecture of consumer 204.

Exchange module 210 is configured to exchange system, connection, and security information with consumer 204, and vice versa, so that integration may be achieved. Activation module 212 activates integration with consumer 204, so that consumer 204, in test module 222 may test the integration to work out any bugs, hang-ups, security flaws, and deficiencies in the integration. Finalization module 214 is configured to push the integration into a final form that is ready for use on the consumer 204 side, with the integration having passed all testing needed.

For the consumer 204, an agreement and/or contract may stipulate the various agreements and terms of the services being provided by vendor 202 to consumer 204. This information may be available in terms module 216 for use by the consumer 204 in verifying that all agreed upon services are being provided. Integration request module 218 begins the integration process by sending a request to the vendor 202 for one or more specific services, or a more general request for services that the vendor 202 may respond to with the services that are available and applicable for the particular consumer 204.

Enablement module 220 is configured to enable integration of the provided services within one or more applications executed and managed by the consumer 204. Test module 222 is configured to test this integration to reveal faults, bugs, hang-ups, deficiencies, security flaws, or any other issues with the integration of the provided service(s) and the consumer application(s). Management module 224 is configured to manage the integrated services within the running applications on the consumer 204 in real-time, live use of the application(s) by users of the consumer application(s).

Once the integrated services are operating within the running applications on the consumer 204 in real-time, one or more users 226 may interact with the various applications and integrated services.

In one or more embodiments, an interface may be provided for allowing user interaction with one or more features of the system 200. An interface may refer to hardware and/or software configured to facilitate communications between a user and a computing device. An interface renders user interface elements and receives input via user interface elements. Examples of an interface include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of an interface are specified in different languages. The behavior of user interface elements is specified in a dynamic programming language, such as JavaScript. The content of user interface elements may be specified in a markup language, such as hypertext markup language (HTML) or XML User Interface Language (XUL). The layout of user interface elements is specified in a style sheet language, such as Cascading Style Sheets (CSS). Alternatively, an interface may be specified in one or more other languages, such as Java, C, or C++.

In one or more embodiments, a data repository may be included in system 200 for storing information for system 200 and may be any type of storage unit and/or device (e.g., a file system, database, collection of tables, or any other storage mechanism) for storing data. Further, the data repository may include multiple different storage units and/or devices. The multiple different storage units and/or devices may or may not be of the same type or located at the same physical site. Further, the data repository may be implemented or may execute on the same computing system as the system 200. Alternatively, or additionally, the data repository may be implemented or executed on a computing system separate from system 200. The data repository may be communicatively coupled to any device for transmission and receipt of data via a direct connection or via a network.

Additional embodiments and/or examples relating to computer networks which may be used to receive and/or transmit information for system 200 are described below in Section 4, titled “Computer Networks and Cloud Networks.”

In an embodiment, system 200 may be implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

### 4. CONNECTED PLATFORM

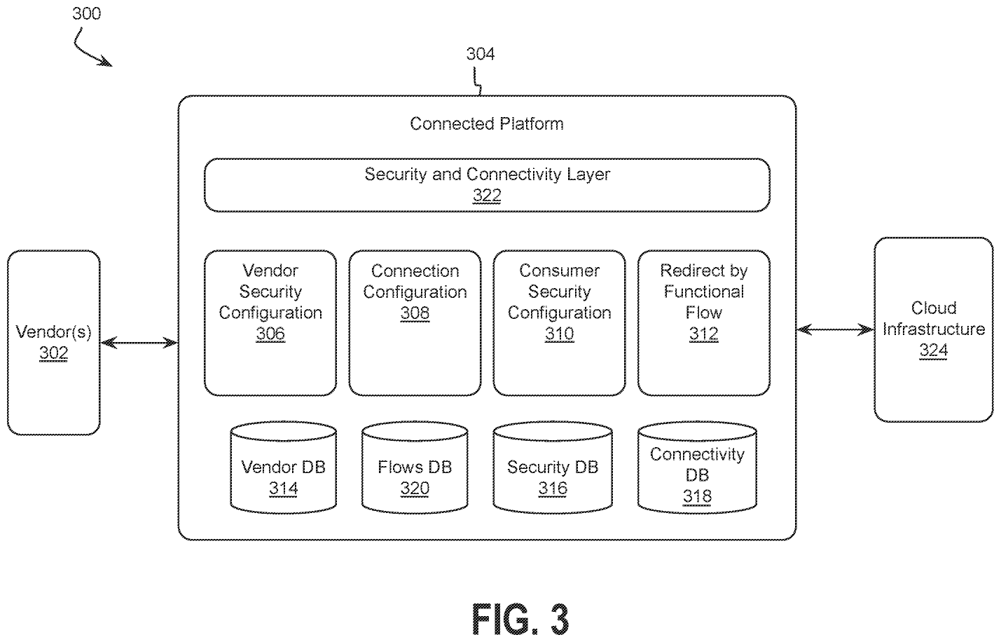

FIG. 3 shows a system 300 that provides a connected platform 304 in accordance with one or more embodiments. System 300 provides an interface for data exchange with one or more vendors 304. The connected platform 304 includes various modules configured to perform different functions for registration, security, enforcement, validation, and service provision for the various vendors 304 and data exchange through the connected platform 304.

In an embodiment, a vendor security configuration module 306 is configured to provide security pattern recognition and provision of security protocols for the various vendors 304. Some example security functions that may be provided by the vendor security configuration module 306 include, but are not limited to, oAuth, mutual or two-way authentication like mTLS, PGP, SSH, data authentication/signing, etc.

In one embodiment, a connection configuration module 308 is configured to provide connections between the various vendors 304 and consumers, and structure and support for providing the services by the vendors 304 for the consumers. Some example connection functions that may be provided by the connection configuration module 308 include, but are not limited to, REST application programming interface (API), secure file transfer protocol (SFTP), webhooks, email, short messaging service (SMS), etc.

According to one embodiment, a consumer security configuration module 310 is configured to provide security pattern recognition and provision of security protocols for the consumers of the services provided by the various vendors 304 via the connected platform. Some example security functions that may be provided by the consumer security configuration module 310 include, but are not limited to, oAuth, mutual or two-way authentication like mTLS, PGP, SSH, data authentication/signing, etc.

In one embodiment, data related to each of the vendors 304 may be stored in a vendor DB 314 or some other storage device. This data may be generated, collected, authenticated, and/or validated by any of the modules 306, 308, 310, 312, in one or more approaches.

According to an approach, data and/or configurations related to each of the various workflows provided by the vendors 304 may be stored in a flows DB 320 or some other storage device. This data may be generated, collected, authenticated, and/or validated by any of the modules 306, 308, 310, 312, in one or more approaches.

According to one approach, data and/or configurations related to security for the vendors and/or data exchanged through the connected platform 304 may be stored in a security DB 316 or some other storage device. This data may be generated, collected, authenticated, and/or validated by any of the modules 306, 308, 310, 312, in one or more approaches.

In one approach, data and/or configurations related to connectivity for the vendors 304 and/or consumers may be stored in a connectivity DB 318 or some other storage device. This data may be generated, collected, authenticated, and/or validated by any of the modules 306, 308, 310, 312, in one or more approaches.

A security and connectivity layer 322 may utilize any of the various modules and databases for configuring services and providing security, validation, and authentication for data exchanged through the connected platform 304, in various approaches. In addition to utilizing the services of the vendors 304, security and connectivity layer 322 may access a cloud infrastructure 324 for providing additional resources and/or functionality beyond or in conjunction with those provided by the connected platform 304.

### 5. EXAMPLE EMBODIMENTS

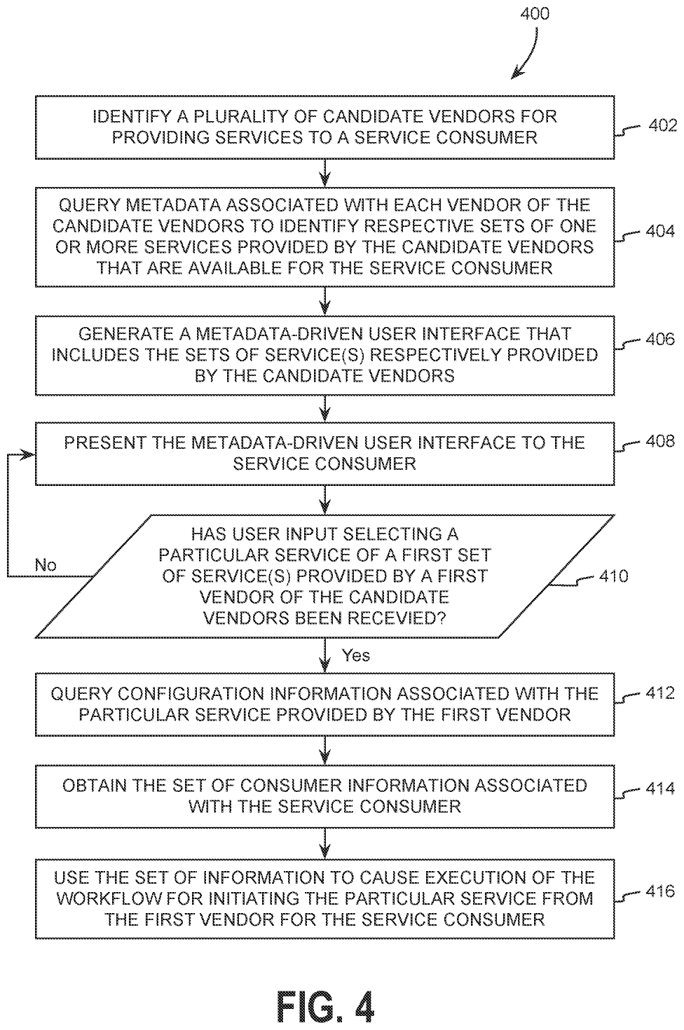

FIG. 4 illustrates an example method 400 for providing services to a service consumer in accordance with one or more embodiments. Method 400, in one embodiment, may be performed by at least one hardware device that includes a hardware processor. One or more operations illustrated in FIG. 4 may be modified, rearranged, or omitted all together. Accordingly, the particular sequence of operations illustrated in FIG. 4 should not be construed as limiting the scope of one or more embodiments.

In operation 402, a system identifies a plurality of candidate vendors for providing services to a service consumer. The candidate vendors may be any vendor that is capable of providing services to the service consumer, either on a business-to-business (B2B) basis or front-facing consumer serving organizations. Some example vendors include, but are not limited to, ride-sharing, financial planning, banking, credit card management, cloud computing, etc. Virtually any modern business may provide some type of services to its own customers, and the system is able to identify which, out of all of the various vendors that have registered or provided data for inclusion in the search, would be able to provide services to the particular service consumer. Moreover, any type of services may be provided, as long as the system is able to ascertain what services are able to be provided by the individual candidate vendors. In addition, some services may not be available for certain types of service consumers (e.g., B2B only, retail only, geographic restrictions, etc.).

In operation 404, the system queries metadata associated with each vendor of the candidate vendors to identify respective sets of service(s) provided by the candidate vendors that are available for the service consumer. In other words, the system ascertains specific services that are applicable and usable by the service consumer out of all services that each of the candidate vendors is capable of providing.

In one embodiment, the metadata associated with a particular vendor may include configuration information corresponding to security for the particular vendor. This security metadata may describe security techniques that are employed by the particular vendor, security protocols used by the particular vendor and designate formats for the security protocols, security requirements of the particular vendor for its own data and any data that may be provided to the particular vendor, and/or security credentials to access data, encrypt data, decrypt data, encode data, decode data, etc.

In an approach, the metadata associated with a particular vendor may include configuration information corresponding to connectivity for data exchange for the particular vendor. This connectivity metadata may describe techniques for connecting to one or more associated services and/or resources, protocols used by the particular vendor for connecting to one or more associated services and/or resources, connection credentials for accessing data, one or more associated services, and/or resources, timing for collecting and/or providing data to one or more associated services and/or resources, requirements, techniques, and/or protocols for encrypting/decrypting data to be exchanged, etc.

In an embodiment, the metadata associated with a particular vendor may include configuration information corresponding to registration for the particular vendor. This registration metadata may enable and/or provide information useful for vendor registration with the connected platform and/or flow registration for enabling one or more particular flows associated with the particular vendor. This registration may be used for real-time workflow registration, that may proceed promptly as the registration metadata is received in an approach. In an example, offline workflows may be described in the metadata and registered for future use.

In operation 406, the system generates a metadata-driven user interface for selection of one or more services. The metadata-driven user interface includes the sets of service(s) respectively provided by the various candidate vendors. This metadata-driven user interface may display the sets of service(s) in any of: drop-down lists, visual listings, tiled view with accompanying text details, etc.

The system analyzes metadata associated with each vendor to generate a set of services that each vendor is capable of providing. Based on these determined services, the system configures the metadata-driven user interface to present the available services. In an approach, the metadata-driven user interface includes information relevant to each service, such as the associated vendor(s), type(s) of data on which the service may be performed, type(s) of data that result from performing the service, security protocol(s) for each service, communication protocol(s) for each service, etc.

In operation 408, the system presents the metadata-driven user interface to the service consumer. This may include sending the metadata-driven user interface to a computing device at the service consumer for use by the computing device, displaying the metadata-driven user interface on a display of the system, providing the metadata-driven user interface to a designated device of the service consumer, etc.

Once the metadata-driven user interface is presented to the service consumer (or individual thereof), one or more user inputs may be received via the metadata-driven user interface to select which of the candidate services are to be provided to the service consumer.

In operation 410, the system determines whether user input selecting a particular service of a first set of service(s) provided by a first vendor of the candidate vendors has been received. When selection of a particular service has been received, method 400 continues to operation 412; otherwise, method 400 returns to operation 408. The selection of the particular service will dictate the other relevant information about the service (e.g., it is from the first set of service(s), it is provided by the first vendor, etc.).

In operation 412, the system queries configuration information associated with the particular service provided by the first vendor. Based on this query, the system is able to ascertain the configuration information for the particular service. In an approach, the configuration information may define a workflow for initiating the particular service from the first vendor for the service consumer.

In an approach, the configuration information may define a set of consumer information that is (a) associated with the service consumer, and (b) used for executing the workflow for initiating the particular service from the first vendor for the service consumer. In a further approach, the configuration information may be provided as metadata in association with the user input selecting the particular service, or in response to the query.

Each service provided by a candidate vendor may have data associated therewith which dictates what information about the service consumer is needed to properly provide the particular service. This information may be provided as metadata in association with the service to be provided, such as a service package.

In operation 414, the system obtains the set of consumer information associated with the service consumer. In one approach, the system may obtain the set of consumer information by polling the service consumer to make determinations about details that are needed by the particular service (e.g., operating system, memory type and size, processor speed and capabilities, network bandwidth, data types, architecture of the service consumer, security credentials, etc.)

Based on the selected service(s) and consumer information, the system generates one or more workflows to input consumer data, process the data in accordance with the selected service(s), and output resultant data after performing the selected service(s). For example, the system may select a security protocol that meets consumer-specific and/or vendor-specific security requirements, and include this security protocol on the input/output side of the data exchange.

In another example, the system may select a communication protocol that meets consumer-specific and/or vendor-specific communication requirements. A workflow is generated that includes this communication protocol on the input/output side of the data exchange such that output data may be transmitted via the selected communication protocol when provided to the consumer.

In operation 416, the system uses the set of consumer information to cause execution of the workflow for initiating the particular service from the first vendor for the service consumer.

According to one embodiment, identifying the plurality of candidate vendors may include identifying a consumer profile associated with the service consumer, determining vendor access criteria based on the consumer profile, and identifying the plurality of candidate vendors from a larger set of candidate vendors based on the vendor access criteria.

The consumer profile may be a data object that stores relevant information about the service consumer. This consumer profile may be created when the service consumer registers or begins working with the system for provision of services, or at any time thereafter. The consumer profile may include name, unique identifier, address(es), number of sites, types of systems, security credentials, etc., that allow the service consumer to be identified and verified when providing services.

In one embodiment, vendor access criteria may include security credentials, tunneling protocols, encryption/decryption information, encoding/decoding information, private and/or virtual network access credentials, service consumers compatible with the services provided by the vendor, etc.

According to one embodiment, generating the metadata-driven user interface may include selecting a layout for the metadata-driven user interface based on the sets of service(s) provided by the candidate vendors. In other words, the number of types of services that are capable of being provided may be used in determining how best to present the sets of service(s) available, and which candidate vendor will provide each particular service. The layout may have any conventional arrangement, including lists, separation into categories, graphical representations and logos, required information to make use of the service, etc.

In an approach, the user input may also select a configuration for the particular service. In this approach, the workflow may be based on the selected configuration. For example, if a service consumer desires ACH transfers over wire transfers, this preference may be indicated in the configuration of the service, and reflected in the workflow that is used to provide the service (e.g., an ACH transfer option will be offered to the service consumer but not a wire transfer option).

According to one embodiment, obtaining the set of consumer information may include obtaining a first subset of the set of consumer information from the service consumer, and generating a second subset of the set of consumer information. This second subset may be based, at least in part, on the first subset of the set of consumer information. In other words, the system may generate a portion of the set of consumer information based on another portion which is provided by and/or acquired from the service consumer. For example, the system may generate a security credential for the service consumer that is needed by the selected service vendor based on information obtained from the service consumer, such as part of a code, a key, etc.

In one or more embodiments, consumer information may change over time. In this case, the system may obtain updated consumer information associated with the service consumer. The updated consumer information may be obtained based on some trigger such as a time period having lapsed, changes to the consumer information being detected, an action taken by the service consumer, an action taken by the service provider, etc. In one approach, the system may obtain the updated consumer information by polling the service consumer to again provide certain information about what is needed to provide the requested service.

Based on the selected service(s) and updated consumer information, the system may generate one or more updated workflows. The updated workflows reflect any changes that have occurred in the updated consumer information, and provide workflows for initiating and providing one or more services. Thereafter, the system uses the updated consumer information to cause execution of the updated workflow for re-initiating the particular service, and/or one or more new services, in accordance with the updated workflows.

### 6. COMPUTER NETWORKS AND CLOUD NETWORKS

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a NAT. Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 7. MISCELLANEOUS; EXTENSIONS

Embodiments are directed to a system with one or more devices that include a hardware processor and that are configured to perform any of the operations described herein and/or recited in any of the claims below.

In an embodiment, a non-transitory computer readable storage medium comprises instructions which, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

### 8. HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

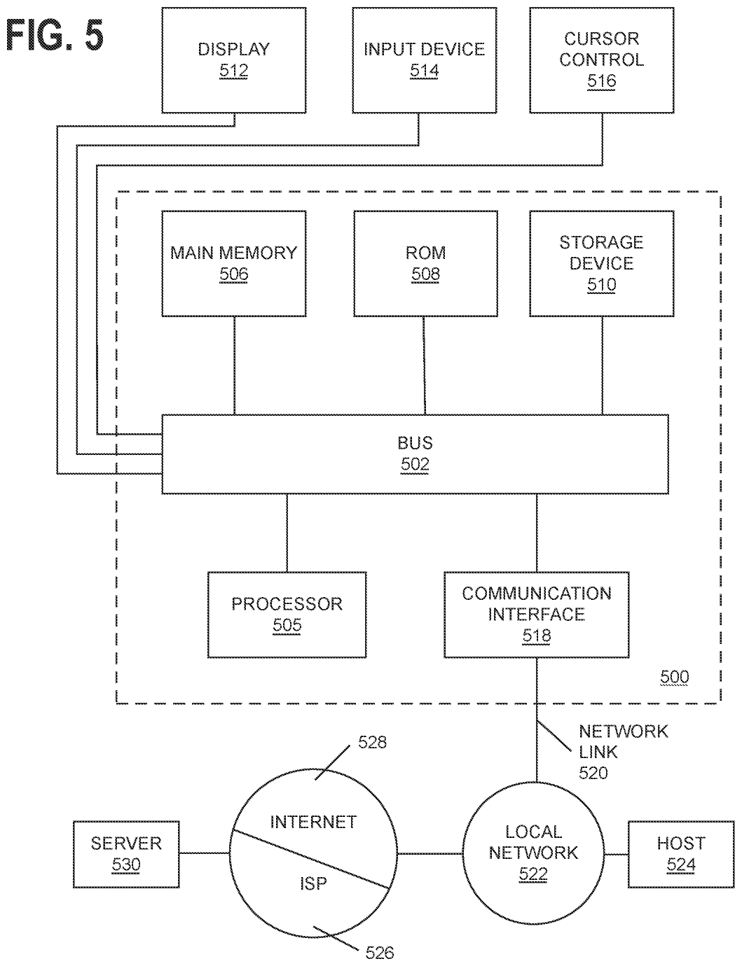

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A non-transitory computer readable medium comprising instructions which, when executed by one or more hardware processors, cause performance of operations comprising:
identifying a plurality of candidate vendors for providing services to a service consumer;
querying metadata associated with each vendor of the plurality of candidate vendors to identify respective sets of one or more services provided by the plurality of candidate vendors that are available for the service consumer;
generating a metadata-driven user interface comprising the sets of one or more services respectively provided by the plurality of candidate vendors;
presenting the metadata-driven user interface to the service consumer;
receiving user input selecting a particular service of a first set of one or more services provided by a first vendor of the plurality of candidate vendors;
querying configuration information associated with the particular service provided by the first vendor, the configuration information defining:
a workflow for initiating the particular service from the first vendor for the service consumer; and
a set of consumer information that is (a) associated with the service consumer, and (b) used for executing the workflow for initiating the particular service from the first vendor for the service consumer;
obtaining the set of consumer information associated with the service consumer; and
using the set of consumer information to cause execution of the workflow for initiating the particular service from the first vendor for the service consumer.

2. The non-transitory computer readable medium as recited in claim 1, wherein the operation for identifying the plurality of candidate vendors comprises operations for:
identifying a consumer profile associated with the service consumer;
determining vendor access criteria based on the consumer profile; and
identifying the plurality of candidate vendors from a set of candidate vendors based on the vendor access criteria.

3. The non-transitory computer readable medium as recited in claim 1, wherein the operation for generating the metadata-driven user interface comprises operations for:
selecting a layout for the metadata-driven user interface based on the sets of one or more services provided by the plurality of candidate vendors.

4. The non-transitory computer readable medium as recited in claim 1, wherein the user input further selects a configuration for the particular service, and wherein the workflow is based on the selected configuration.

5. The non-transitory computer readable medium as recited in claim 1, wherein the operation for obtaining the set of consumer information comprises operations for:
obtaining a first subset of the set of consumer information from the service consumer; and
generating a second subset of the set of consumer information based at least in part on the first subset of the set of consumer information.

6. The non-transitory computer readable medium as recited in claim 1, wherein the metadata associated with a particular vendor of the plurality of candidate vendors comprises configuration information corresponding to security for the particular vendor.

7. The non-transitory computer readable medium as recited in claim 1, wherein the metadata associated with a particular vendor of the plurality of candidate vendors comprises configuration information corresponding to connectivity for data exchange for the particular vendor.

8. The non-transitory computer readable medium as recited in claim 1, wherein the metadata associated with a particular vendor of the plurality of candidate vendors comprises configuration information corresponding to registration for the particular vendor.

9. A method comprising:
identifying a plurality of candidate vendors for providing services to a service consumer;
querying metadata associated with each vendor of the plurality of candidate vendors to identify respective sets of one or more services provided by the plurality of candidate vendors that are available for the service consumer;
generating a metadata-driven user interface comprising the sets of one or more services respectively provided by the plurality of candidate vendors;
presenting the metadata-driven user interface to the service consumer;
receiving user input selecting a particular service of a first set of one or more services provided by a first vendor of the plurality of candidate vendors;
querying configuration information associated with the particular service provided by the first vendor, the configuration information defining:
a workflow for initiating the particular service from the first vendor for the service consumer; and
a set of consumer information that is (a) associated with the service consumer, and (b) used for executing the workflow for initiating the particular service from the first vendor for the service consumer;
obtaining the set of consumer information associated with the service consumer; and
using the set of consumer information to cause execution of the workflow for initiating the particular service from the first vendor for the service consumer.

10. The method as recited in claim 9, wherein identifying the plurality of candidate vendors comprises:
identifying a consumer profile associated with the service consumer;
determining vendor access criteria based on the consumer profile; and
identifying the plurality of candidate vendors from a set of candidate vendors based on the vendor access criteria.

11. The method as recited in claim 9, wherein generating the metadata-driven user interface comprises:
selecting a layout for the metadata-driven user interface based on the sets of one or more services provided by the plurality of candidate vendors.

12. The method as recited in claim 9, wherein the user input further selects a configuration for the particular service, and wherein the workflow is based on the selected configuration.

13. The method as recited in claim 9, wherein obtaining the set of consumer information comprises:
obtaining a first subset of the set of consumer information from the service consumer; and
generating a second subset of the set of consumer information based at least in part on the first subset of the set of consumer information.

14. The method as recited in claim 9, wherein the metadata associated with a particular vendor of the plurality of candidate vendors comprises configuration information corresponding to security for the particular vendor.

15. The method as recited in claim 9, wherein the metadata associated with a particular vendor of the plurality of candidate vendors comprises configuration information corresponding to connectivity for data exchange for the particular vendor.

16. The method as recited in claim 9, wherein the metadata associated with a particular vendor of the plurality of candidate vendors comprises configuration information corresponding to registration for the particular vendor.

17. A system comprising:
at least one hardware processor; and
a non-transitory computer readable medium comprising instructions which, when executed by the at least one hardware processor, cause performance of operations comprising:
identifying a plurality of candidate vendors for providing services to a service consumer;
querying metadata associated with each vendor of the plurality of candidate vendors to identify respective sets of one or more services provided by the plurality of candidate vendors that are available for the service consumer;
generating a metadata-driven user interface comprising the sets of one or more services respectively provided by the plurality of candidate vendors;
presenting the metadata-driven user interface to the service consumer;
receiving user input selecting a particular service of a first set of one or more services provided by a first vendor of the plurality of candidate vendors;
querying configuration information associated with the particular service provided by the first vendor, the configuration information defining:
a workflow for initiating the particular service from the first vendor for the service consumer; and
a set of consumer information that is (a) associated with the service consumer, and (b) used for executing the workflow for initiating the particular service from the first vendor for the service consumer;
obtaining the set of consumer information associated with the service consumer; and
using the set of consumer information to cause execution of the workflow for initiating the particular service from the first vendor for the service consumer.

18. The system as recited in claim 17, wherein the operation for identifying the plurality of candidate vendors comprises operations for:
identifying a consumer profile associated with the service consumer;
determining vendor access criteria based on the consumer profile; and
identifying the plurality of candidate vendors from a set of candidate vendors based on the vendor access criteria.

19. The system as recited in claim 17, wherein the operation for generating the metadata-driven user interface comprises operations for:
selecting a layout for the metadata-driven user interface based on the sets of one or more services provided by the plurality of candidate vendors.

20. The system as recited in claim 17, wherein the user input further selects a configuration for the particular service, and wherein the workflow is based on the selected configuration.

21. The system as recited in claim 17, wherein the operation for obtaining the set of consumer information comprises operations for:
obtaining a first subset of the set of consumer information from the service consumer; and
generating a second subset of the set of consumer information based at least in part on the first subset of the set of consumer information.

22. The system as recited in claim 17, wherein the metadata associated with a particular vendor of the plurality of candidate vendors comprises configuration information corresponding to security for the particular vendor.

23. The system as recited in claim 17, wherein the metadata associated with a particular vendor of the plurality of candidate vendors comprises configuration information corresponding to connectivity for data exchange for the particular vendor.

24. The system as recited in claim 17, wherein the metadata associated with a particular vendor of the plurality of candidate vendors comprises configuration information corresponding to registration for the particular vendor.
